(19) United States
(12) Patent Application Publication
(10) Pub. No.: US 2016/0104310 A1
(43) Pub. Date: Apr. 14, 2016

(54) SYSTEMS AND METHODS OF BLENDING MACHINE-READABLE AND HUMAN-READABLE ELEMENTS ON A DISPLAY

(71) Applicant: SCHNEIDER ELECTRIC USA INC., Palatine, IL (US)

(72) Inventors: John C. Van Gorp, Sidney (CA); Patrick Wilkerson, Saanichton (CA)

(21) Appl. No.: 14/894,104

(22) PCT Filed: Jun. 28, 2013
(86) PCT No.: PCT/US13/48629

§ 371 Date: Nov. 25, 2015

(51) Int. Cl. G06T 11/60; G06K 7/14

(52) U.S. Cl. CPC G06T 11/60; G06K 7/1417

(57) ABSTRACT

According to various aspects and embodiments, a system and method for communicating at least one human-readable element and at least one fiduciary marker is provided. The system includes a programmable device. The programmable device includes a memory, a display, and at least one processor coupled to the memory. The at least one processor coupled to the memory is configured to generate a plurality of frames that render the at least one human-readable element perceptible to human view during display of the plurality of frames via the display, that render the at least one fiduciary marker detectable to an image capture device during display of the plurality of frames via the display, and that obscure the at least one fiduciary marker from human view during display of the plurality of frames via the display, and display the plurality of frames via the display.

### BACKGROUND

1. Technical Field

The technical field relates generally to communication of information between people and computing devices, and more particularly, to systems and methods for displaying human-readable elements in concert with machine-readable elements.

2. Background Discussion

Computers exchange information using a variety of communication technologies that may be broadly classified into wired and wireless technologies. Examples of wired technologies include Ethernet and RS-485 based technologies. Examples of wireless technologies include optical and radio frequency based technologies. Each technology provides advantages and disadvantages that affect the suitability of exchanging information using these technologies.

For example, in a data center environment, servers housed in racks may exchange information with other computer systems using wired, Ethernet connections, as these connections provide high throughput relative to wireless connections. The data center environment may also include mobile computer systems used by data center personnel to locate, inventory, and monitor data center equipment. Given the data center personnel's need to move about the data center, wireless connections are typically better suited for these mobile computer systems. Similar concerns regarding mobility make wireless connections better suited in other contexts, such as when applied to personnel charged with monitoring or management of automated process controls, electrical distribution systems, or the like.

### SUMMARY

Several conventional methods exist for communicating data between computer systems. One example is exchanging data via a wired communications port such as an Ethernet or an RS-485 port. Other examples include wireless methods such as optical ports and other wireless links between the communication device 108 and a target device. Embodiments disclosed herein manifest an appreciation that conventional methods may be cost prohibitive and logistically difficult to implement and maintain. Wire-based methods offer continuous data streams from the target device, but may be expensive to install and require a user to potentially carry a device, or devices, with a variety of legacy interfaces. Wireless communication links avoid some issues of wired communication methods, but often require additional configuration to enable and disable the use of the communication method. The additional configuration may require advanced training for the user on the device, and in some cases, undesirable minimizing/disabling of the security mechanisms which protect access to a device and its operation.

According to various aspects and embodiments, a system for communicating at least one human-readable element and at least one fiduciary marker is provided. The system to includes a programmable device. The programmable device includes a memory, a display, and at least one processor coupled to the memory. The at least one processor coupled to the memory is configured to generate a plurality of frames that render the at least one human-readable element perceptible to human view during display of the plurality of frames via the display, that render the at least one fiduciary marker detectable to an image capture device during display of the plurality of frames via the display, and that obscure the at least one fiduciary marker from human view during display of the plurality of frames via the display, and display the plurality of frames via the display.

In the system, the programmable device may be at least one of a programmable logical controller, a utility meter, a protection relay, and an uninterruptible power supply. The at least one processor may be configured to generate the plurality of frames by generating a plurality of frames that render the at least one fiduciary marker imperceptible to human view. The at least one fiduciary marker may include at least one of a quick response code and a one-dimensional bar code.

In the system, the display may be configured to display a plurality of distinct colors including a first color and a second color. The processor may be further configured to render at least one frame of the plurality of frames to include the at least one human-readable element in the first color and the at least one fiduciary marker in the second color, and render an overlaid image within the at least one frame, the overlaid image including at least a portion of the at least one human-readable element and at least one portion of the at least one fiduciary marker.

In the system, at least one frame of the plurality of frames may include at least one portion of the at least one fiduciary marker, and at least one other frame of the plurality of frames may include at least one remaining portion of the at least one fiduciary marker. The plurality of frames may include at least one frame including only the at least one fiduciary marker.

In the system, each frame of the plurality of frames may be partitioned into a plurality of areas, each area of the plurality of areas having a distinct rendering speed. The at least one processor may be further configured to display at least a portion of the at least one fiduciary marker within an area of the plurality of areas having a rendering speed that is faster than a rendering speed of another area of the plurality of areas.

In the system, at least one fiduciary marker may include at least one encoded parameter associated with the programmable device. The at least one encoded parameter may include a to sensor value. The at least one encoded parameter may include at least one of an operational state, a global positioning system (GPS) location, a device ID, a model number, a serial number, an internet protocol (IP) address and a serial number.

In the system, the plurality of frames may include a first subset of the plurality of frames including a first fiduciary marker and a second subset of the plurality of frames including a second fiduciary marker. The at least one of the first fiduciary marker and the second fiduciary marker may include a synchronization image comprising at least one of a start-of-transmission parameter and an end-of-transmission parameter, the start-of-transmission parameter indicating a starting frame of at least one of the first subset and the second subset, the end-of-transmission parameter indicating an ending frame of at least one of the first subset and the second subset.

The system may further include a communication device. The communication device includes a memory, an image capture device, and at least one processor coupled to the memory and the image capture device. The at least one processor may be configured to capture at least one frame of the plurality of frames using the image capture device, identify the at least one least one fiduciary marker within the at least one frame, and decode the at least one encoded parameter from the at least one fiduciary marker.

According to another embodiment, a method for communicating at least one human-readable element and at least one fiduciary marker using a computer system including a memory, a display, and at least one processor coupled to the memory and the display is provided. The method includes the acts of generating a plurality of frames that render the at least one human-readable element perceptible to human view during display of the plurality of frames via the display, that render the at least one fiduciary marker detectable to an image capture device during display of the plurality of frames via the display, and that obscure the at least one fiduciary marker from human view during display of the plurality of frames via the display, and displaying the plurality of frames via the display.

The method may further include the acts of rendering at least one frame of the plurality of frames to include the at least one human-readable element in a first color and the at least one fiduciary marker in a second color, and rendering an overlaid image within the at least one frame, the overlaid image including at least a portion of the at least one human-readable element and at least one portion of the at least one fiduciary marker. The act of rendering the at least one frame of the plurality of frames may include at least one portion of the at least one fiduciary marker, and at least one other frame of the plurality of frames includes at least one to remaining portion of the at least one fiduciary marker.

According to another embodiment, a programmable device for detecting at least one obscured fiduciary marker is provided. The programmable device includes a memory, an image capture device, and at least one processor coupled to the memory and the image capture device. The at least one processor may be configured to capture a plurality of frames from a screen using the image capture device, the plurality of frames including the at least one obscured fiduciary marker and at least one human-readable element, identify the at least one obscured fiduciary marker within at least one frame of the plurality of frames, and store the at least one obscured fiduciary marker in the memory.

The programmable device may further include a display. In the programmable device, the at least one processor may be further configured to decode information encoded within the at least one obscured fiduciary marker, and display, the decoded information via the display.

In the programmable device, the at least one frame may be a first frame and a second frame. The at least one processor may be further configured to detect the first frame including a first portion of the at least one obscured fiduciary marker, detect the second frame including a second portion of the at least one obscured fiduciary marker, combine the first portion and the second portion to render a complete fiduciary marker, and store the complete fiduciary marker in the memory.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed subject matter. Particular references to examples and embodiments, such as “an embodiment,” “an other embodiment,” “some embodiments,” “other embodiments,” “an alternate embodiment,” “various embodiments,” “one embodiment,” “at least one embodiments,” “this and other embodiments” or the like, are not necessarily mutually exclusive and are intended to indicate that a particular feature, structure, or characteristic described in connection with the embodiment or example and may be included in that embodiment or example and other embodiments or examples. The appearances of such terms herein are not necessarily all referring to the same embodiment or example.

Furthermore, in the event of inconsistent usages of terms between this document and documents incorporated herein by reference, the term usage in the incorporated references is to supplementary to that of this document; for irreconcilable inconsistencies, the term usage in this document controls. In addition, the accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram including an example system for blending fiducials;

FIG. 2 is a block diagram of an example programmable device that executes processes and functions disclosed herein;

FIG. 3 is a block diagram of an example of a computer system that executes processes and functions disclosed herein;

FIG. 4 is a diagram including an example system for blending fiducials;

FIG. 5 is a diagram of an example device display according to one embodiment;

FIG. 6 is a diagram of another example device display according to various embodiments;

FIG. 7 is a flow diagram of an example fiducial blending process;

FIG. 8 is a flow diagram of an example fiducial blending request process;

FIG. 9 is a flow diagram of an example frame generation process; and

FIG. 10 is a flow diagram of an example fiducial detection process.

### DETAILED DESCRIPTION

Some embodiments disclosed herein include apparatus and processes for to communicating human-readable elements via a display device (or display screen) while simultaneously displaying imperceptible, or nearly-imperceptible, machine-readable elements. According to various embodiments, imperceptible machine-readable elements may be entirely undetectable by the unaided human eye. In certain other embodiments, machine-readable elements may be obscured and have minimal impact on the human-readable elements. According to these embodiments, communication of the human-readable elements may be optimized such that a user viewing the display device is unaware of the presence of one or more machine-readable elements interlaced, and/or blended, with the human-readable elements. In at least one embodiment, the machine-readable elements comprise a one- or two-dimensional barcode. In these embodiments, the programmable device may encode information such as, for example, measurements from a sensor or other collected information including diagnostic codes and logged device events. In other embodiments, data values such as an Internet Protocol (IP) address, serial number, Media Access Control (MAC) address, hostname, model number, location, or other identifying information may be encoded and displayed.

In another embodiment of the present invention, methods and apparatuses for capturing one of more frames displayed by the display device are provided. For example, such apparatus may comprise a mobile computer device, such as a smart phone with a built-in camera. The mobile computing device detects the barcode within a captured sequence of frames, and then decodes the information encoded within the barcode. In some embodiments, the decoded information may be transmitted to a data center management system (e.g., wirelessly). In other embodiments, the captured frames may be stored but not otherwise processed by the mobile computer device. Thus, a user can walk from one display device to another with, for example, a smart phone in hand, retrieve the encoded information for any piece of equipment simply by capturing a short video (or rapid sequence of frames) from the display of each device.

Two-dimensional barcodes may be used in some embodiments. One example of a two-dimensional bar code is a Quick Response (QR) code developed by Denso Wave Inc. of Chita-gun, Aichi, Japan. QR codes are an improvement over the conventional one-dimensional bar codes because more data can be encoded in the pattern over a two-dimensional surface. In addition, QR codes include robust error correction that makes them ideal in scenarios where light conditions or quality of a particular display may impact readability of the QR code. Among other fields, QR codes are widely used in industrial management, such as for asset identification, inventory management and diagnostics. One such approach is disclosed in Patent Cooperation Treaty No. WO/2013/046231A1, entitled DYNAMIC QUICK RESPONSE to (QR) CODE WITH EMBEDDED MONITORING DATA FOR EASE OF MOBILE ACCESS, filed on Sep. 26, 2012, which is hereby incorporated herein by reference in its entirety (referred herein as “the WO/2013/046231 application”). As disclosed in the WO/2013/046231 application, the device displaying the image codes must enter a specific mode before displaying the image codes. In a normal-mode of operation, the device displays human-readable elements such as numeric or textual data values. To display the image codes, the user executes an operation using the user interface to instruct the device to display one or more image codes instead of human-readable elements. For example, the device may have a physical button, or another user interface with actionable elements, that changes the device from a state displaying the human-readable elements to a state displaying the machine-readable elements.

Once displayed, a fiduciary marker, or fiducial, having a two-dimensional barcode is photographed by a camera, and the data in the bar code is then extracted from the image by a compatible device. Several existing open-source toolkits exist for detecting and analyzing fiduciary markers within still and live video feeds. For example, toolkits such as ARToolKit, ARToolKitPlus, and ZXing, may be used in conjunction with various embodiments.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity.

References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. to References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Fiducial Blending System

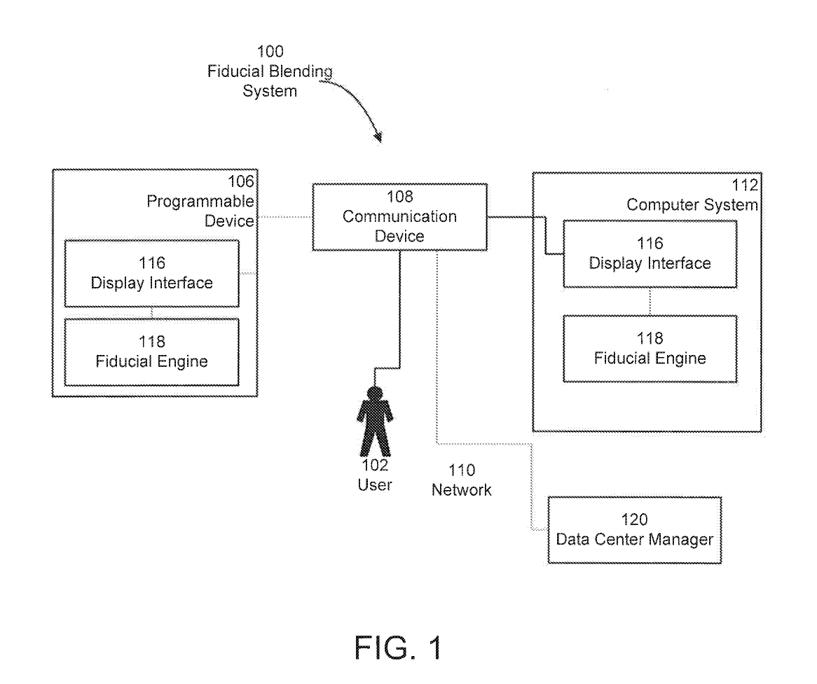

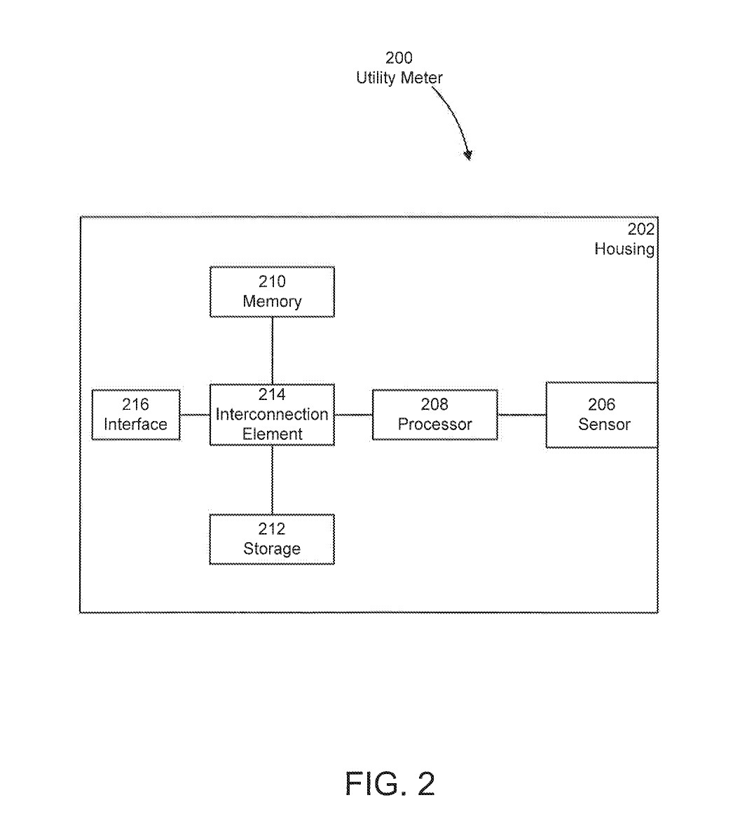

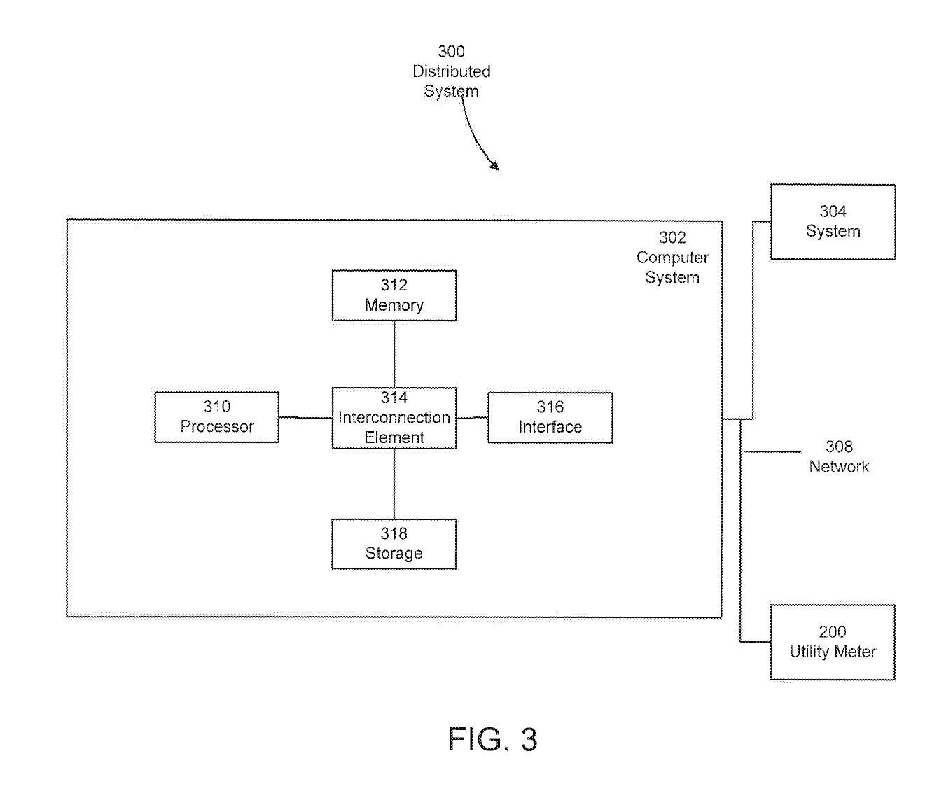

Some embodiments disclosed herein implement a fiducial blending system using one or more computer systems, such as the computer systems described below with reference to FIG. 3. According to these embodiments, a fiducial blending system communicates human-readable elements as well as machine-readable elements imperceptible to an unaided human eye. These machine-readable elements may communicate data identical to the human-readable elements, or communicate data not otherwise communicated via human-readable elements. FIG. 1 illustrates an example fiducial blending system generally designated at 100. As shown, FIG. 1 includes a programmable device 106, a user 102, a communication device 108, and a computer system 112. The programmable device may include any device with configurable operations, such as the programmable device described below with reference to FIG. 2. The communication device may include a mobile computing device such as a laptop computer, a tablet computer, personal heads-up display (e.g., Google Goggles developed by Google Inc. of Mountain View, Calif.), a cellular phone (e.g., smart phone), personal digital assistant, or any other portable device configured with a built-in digital camera. The computer system 112 may include one or more computer systems, such as the computer system described below with reference to FIG. 3.

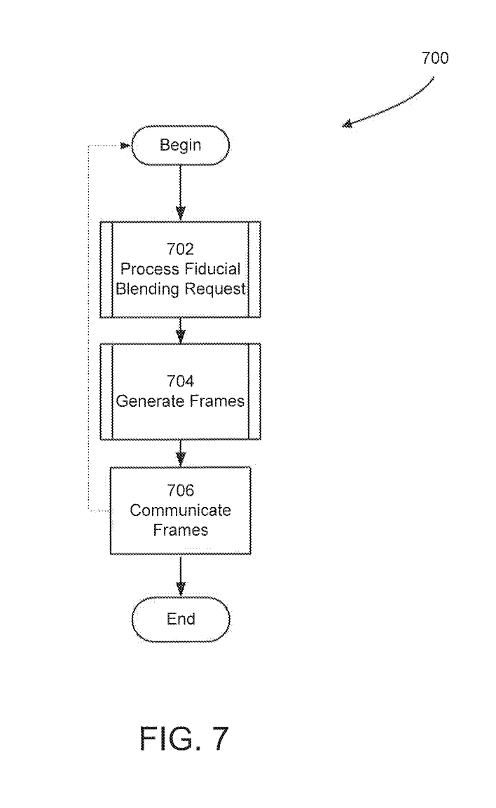

As illustrated in FIG. 1, the computer system 112, the user 102, and the communication device 108 exchange information via a display interface 116. A fiducial blending engine 118 and a display interface 116 are configured to communicate information with the communication device 108 in support of the processes described below with reference to FIGS. 7, 8, 9, and 10. The display interface may visually communicate human-readable and machine-readable elements utilizing one or more display devices associated with the display interface 116. For example, the display device may be a device such as a mono-chrome display or a color LCD display. Such display devices are common within human-to-machine interfaces that allow a user to effectively operate and control a device, as well as receive to feedback from the device which aids the user in making operational decisions. The display interface 116 may also include input elements such as physical interface hardware (e.g., keyboard, touch-capacitive elements, tactile buttons, switches, LEDs) and software components (e.g., firmware, drivers and software libraries for displaying information via the display device), which will be collectively referred to as an interface herein.

It should be understood that the display interface 116 may be included in any number of devices, such as the programmable device 106, monitoring and control devices, embedded devices, and industrial control panels. In various embodiments, the display interface 116 of the programmable device 106 may be identically configured to that of the display interface 116 in the computer system 112. In other embodiments, the display interface 116 may be configured with different hardware and software components.

In the embodiment illustrated in FIG. 1, the data center manager 120 includes a computer executing software configured to control, monitor, and manage devices (e.g., programmable device 106) located within a data center. Such software may, for example, perform one or more of the following monitoring and automation functions: alarming and notification, control, status, visualization, configuration, reporting, and analytics. It should be understood that the data center manager 120 may perform other functions, such as data collection/gathering, resource planning/allocation, and/or implementation (e.g., change tracking, inventory tracking, dependency analysis, and prediction and modeling), and that other systems may be used to perform one more of these functions.

In one embodiment, the communication device 108 communicates with, and serves as a user interface for, the data center manager 120. For example, the communication device 108 may be a mobile computing device connected to the network 110. The communication device may run software (e.g., an ‘app’) that is configured to provide the user with a graphical user interface that enables the user to view alarms, warnings, and other messages pertaining to one or more of the devices in the data center. In another example, the communication device may enable the user to control one or more of the devices in the data center via the network 110.

In at least one embodiment, the user 102 is able to access machine-readable elements using the programmable device 106 without performing control operations to enable a special interface mode of the programmable device 106. The machine-readable elements displayed within the display interface 116 may include a wide variety of encoded information including information about any aspect of the programmable device 106. Examples of information regarding the programmable device 106 include sensor readings, diagnostic codes, and configuration parameters. Thus, the user may approach the programmable device 106 with the communication device 108 and a capture series of images displayed by the display interface 116. A plurality of frames communicated by the display interface 116 may include one or more fiduciary markers which are obscure or imperceptible to the unaided eye of the user; however, the one or more fiduciary markers may be detected by the communication device 108 which is generally configured to capture the plurality of images at a frame rate faster than a human eye can perceive. In one embodiment, the communication device may process the captured frames in real-time, or near real-time, to extract one or more frames including the fiduciary markers. In another embodiment, the communication device 108 may store the captured images for later processing by a computer system, such as the data center manager 120.

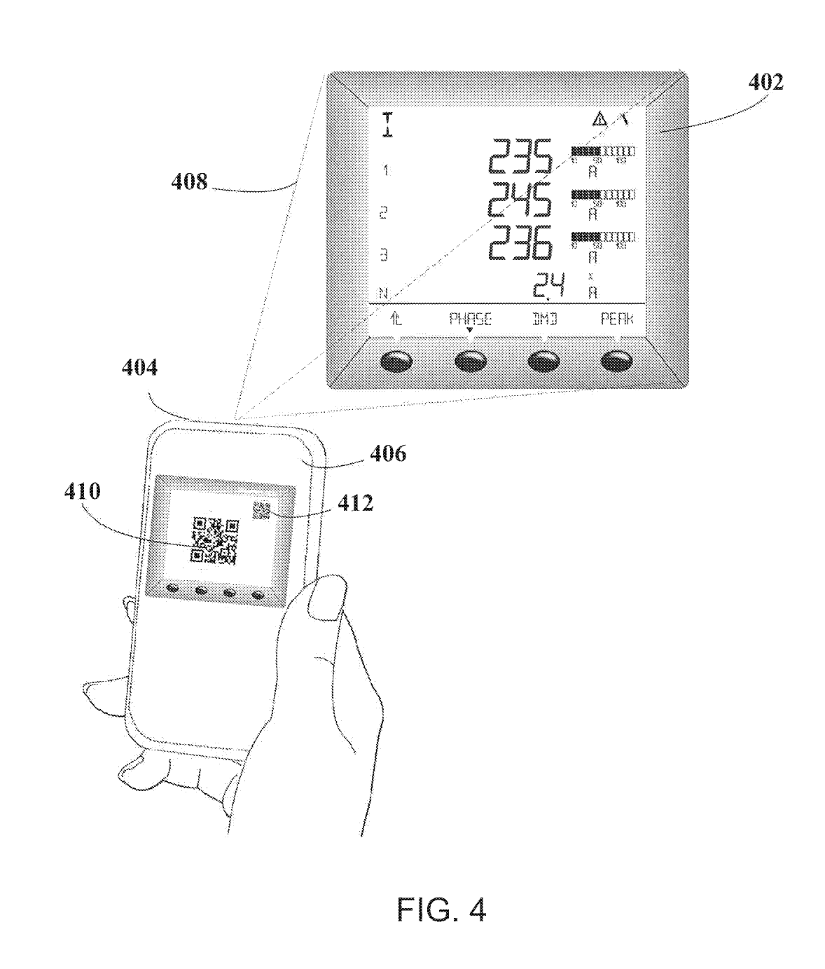

FIG. 4 illustrates one embodiment including a display device 402 associated with the display interface 116 (FIG. 1), a mobile computing device 404 carried by the user 102 (FIG. 1), a display device 406, and machine readable elements at 410 and 412. The mobile computing device 404 includes an image capture device, such as a built-in digital camera and display 406. One example of a mobile computing device 404 includes an iPhone by Apple Inc. of Cupertino, Calif. According to one embodiment, a user 102 carrying the mobile computing device 404 approaches the display device 402 and captures a plurality of images in a field of view 408 of the built-in digital camera. The plurality of images may be a video or a series of discrete images. According to some embodiments, the mobile computing device 404 may detect one or more fiduciary markers within the captured images in real-time or during post capture processing of the images. In one embodiment, the mobile computing device 404 may detect one or more fiduciary markers (e.g., fiduciary markers 410 and 412) and display them in various ways using the display 406.

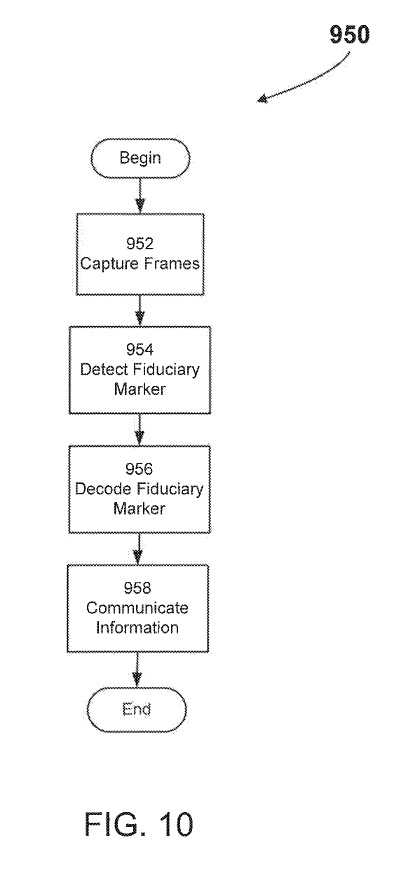

For example, in the embodiment illustrated in FIG. 4, the mobile computing device 404 displays a detected fiduciary marker 410 within one or more captured images. In this example, the overlaid fiduciary marker provides an indication to the user that one or more fiduciary markers have been detected. In another example, the display device 402 may indicate that a particular cycle, or sequence, of fiduciary markers have been displayed allowing a user 102 (FIG. 1) to determine if an adequate number of frames have been captured. In still other examples, the mobile computing device 404 may indicate the successful detection of one or more fiduciary markers, such as in support of the fiducial detection process discussed below with reference to FIG. 10, using the display 406. In a related example, the mobile computing to device 404 may display an isolated representation (i.e., only display the fiduciary marker) of the one or more detected fiduciary markers. According to these examples, an overlaid fiduciary marker or an isolated fiduciary marker may be displayed in a slideshow format allowing the user to advance through each captured fiduciary marker and corresponding frame. In another example, the mobile computing device 404 may provide a toggle function allowing the user to switch between viewing overlaid or isolated frames of the captured images.

In still other embodiments, the mobile computing device 404 may decode the one or more detected fiduciary markers and extract information pertaining to a hardware device (e.g., the computer system 112 of FIG. 1) associated with the display device 402. In one embodiment, the mobile computing device 404 includes software for scanning and decoding the fiduciary marker using conventional techniques. For QR codes, such software is widely available for several mobile operating system platforms, including, for example, iOS by Apple Inc., Blackberry® OS By Research in Motion of Waterloo, Ontario, Canada and the Android operating system developed in part by Google Inc. of Mountain View, Calif.

The scanning/decoding software is configured to detect at least one fiduciary marker anywhere within one or more of the captured images and decode information (e.g., information pertaining to the hardware device) encoded within the fiduciary marker(s). A discussed above, the information may contain, for example, measurement readings from a sensor and configuration parameters of the hardware device associated with the display device 402. The configuration parameters may include data values including an operational state, a global positioning (GPS) location, a device ID, a model number, a serial number, an internet protocol (IP) address and a serial number of the hardware device. This meta-data may be used by the mobile computing device 404 to display the corresponding information directly to the user 102. In one embodiment, the mobile computing device 404 may transmit the identification information of the hardware device via the network 110 (using fixed-wire, Wi-Fi, 3G, 4G or other wireless data communication standards) to the data center manager 120 (FIG. 1) and receive status information in response. The mobile computing device 404 may also transmit commands to execute control operations on the hardware device associated with the display device 402 through the network 110 (FIG. 1) either directly via the hardware device or through the data center manager 120 operating as a proxy. In one embodiment, the status information received by the mobile computing device 404 may contain a security token allowing for such operations to be executed.

In still other embodiments, the configuration parameters may include one or more communication protocols available to communicate directly with the hardware device associated with the display device 402. For example, the configuration parameters may include information pertaining to Near Field Communication (NFC) with the hardware device (e.g., using Bluetooth or Wi-Fi). It should be understood that the configuration parameters, or other data decoded from the fiduciary marker, may be used to setup virtually any type of secured or unsecured connection with the hardware device associated with the display device 402 known in art. The connections with the hardware device may be used to receive additional data from the hardware device or to perform control functions on the hardware device.

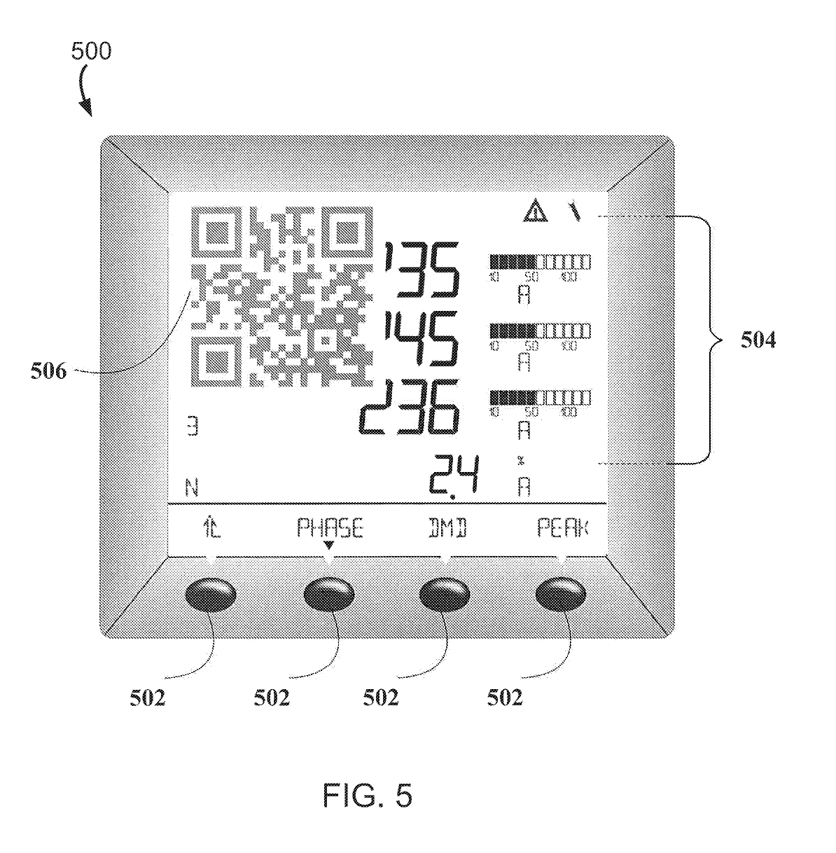

FIG. 5 illustrates one embodiment of the display device 402 of FIG. 4 generally designated at 500 which includes interface buttons 502, human-readable elements 504, and a fiduciary marker 506. As shown in FIG. 5, the display device 500 may be configured as a monochrome display. In other embodiments, the display device 500 may be capable of displaying two or more colors. Further, the embodiment shown in FIG. 5 includes four interface buttons 502. In other embodiments, additional or fewer interface buttons may be present. In certain other embodiments, the display device may not be configured with interface buttons 502 or may be configured with a mounted panel/locked compartment protecting the interface buttons 502 from user access.

The maximum potential frame rates and refresh rates of modem LCDs afford a certain amount of “headroom” frames that may be altered or exchanged with little or no visible effect noticed by a person viewing the display device. Headroom frames, as defined herein, are the number of frames that may be replaced or altered before being perceptible to a human's unaided eye. According to one embodiment, the display device 500 is configured with a common frame rate of 24 frames per second with a 60 Hz refresh rate. In this embodiment, the display device 500 renders 24 individual frames per second (1000 ms/24 frames per second=41.667 ms), with a redraw (refresh) of frames occurring approximately every 17 ms (1000 ms/60 Hz=16.667 ms). In this embodiment, replacing a single frame which is rendered for 41 ms may obscure the replaced frame from human perception, or in some cases, make the replaced frame entirely imperceptible depending on factors such as movement of elements on the screen, coloration of the elements, etc. In another embodiment, the display device 500 configured to operate at a frame rate rendering each frame for 10 ms, or less. In this embodiment, the replacement of one or more of the frames would render the replaced frame imperceptible to the human eye as the human eye is incapable of detecting a change under 10 ms in duration.

According to various embodiments, the fiducial blending engine 118 (FIG. 1) may replace or modify a number of frames in order to interleave and/or blend frames including one or more fiduciary markers. For example, the fiducial blending engine 118 may direct the display device 500 to alternate between displaying 1 frame with machine-readable elements followed by 5 frames of human-readable elements, totaling 24 frames per cycle. In another example, the fiducial blending engine 118 may direct the display device 500 to alternate between showing 2 frames with machine-readable elements followed by 10 frames of human-readable elements, totaling 24 frames per cycle. In this example, the grouping of machine-readable element frames may enable a mobile capture device, such as the mobile capture device 404 as discussed above with reference to FIG. 4, to more easily capture the entirety of all of the frames including the machine-readable elements. It should be understood that 24 frames per second with 60 Hz refresh is just one rate at which the display device 500 may operate. For example, a higher frame rate may be advantageous in certain embodiments. A higher frame rate may provide additional “headroom” frames, and in turn, a higher number of frames with the potential to include obscured machine-readable elements (i.e., a higher data transfer rate to the mobile computing device 404 of FIG. 2). Likewise, operating at a slower frame rate and refresh rate may increase compatibility with mobile computing devices which are unable to capture a high rate of frames while still rendering the machine-readable frames virtually imperceptible to the unaided human eye.

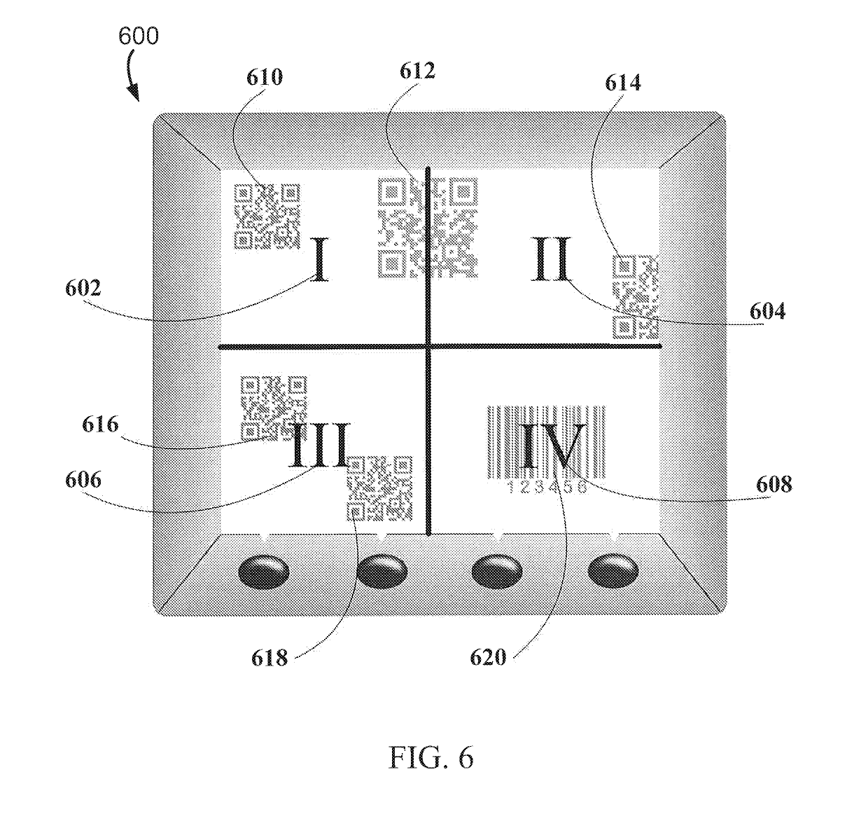

According to a variety of embodiments, the fiduciary markers included within a frame vary in type, number, size, shape, and relative position. Further discussion regarding the various alternative representations of the machine-readable elements visualized by the display device 500 may be found below with reference to FIG. 6.

In the embodiment shown, a machine readable element 506 in the form of a fiduciary marker is not perceptible to the unaided human eye (as indicated by the transparency of the fiduciary marker 506). A ratio of the frames displayed with human-readable elements 504 versus machine-readable element 506 may obscure the machine-readable element 506 frames from visual detection (or perception) by user 102 (FIG. 1). A user may otherwise be unaware of the presence of the displayed fiducial makers without the aid of a mobile computing device capable of detecting the fiduciary markers, such as the mobile computing device 404 discussed above with reference to FIG. 4. In one embodiment, the display device 500 may include a user-configurable parameter that adjusts the maximum number of frames to be interleaved which include machine-readable elements. In another embodiment, a user may execute a procedure whereby interface buttons 502 are pressed by the user 102 (FIG. 1) to adjust the ratio of human-readable frames to the machine-readable frames displayed. In another example, it may be advantageous for a user 102 (FIG. 1) to adjust the ratio to a rate at which the fiduciary marker frames become perceptible to the user's unaided eye in order to confirm the presence of machine-readable elements when troubleshooting or in certain production environments.

Still in reference to FIG. 5, in some embodiments, the hardware display device may be limited to a frame rate well under 24 frames per second, and thus, make the obscuring of the interleaved machine-readable element frames difficult. In addition, certain display types may have a limited ability to perform high frequency refresh rates. In some of these embodiments, it may be advantageous to blend the fiduciary marker 506 in an obscured, yet a semi-visible, fashion with the human-readable elements 504.

According to this embodiment, the display device 500 is a multi-color display capable of displaying at least two distinct colors. The fiducial blending engine 118 (FIG. 1) then selects a color or shade that may be computationally differentiated from colors used in rendering the human-readable elements 504. The color selected by the fiducial blending engine 118 may be a color or shade that ideally does not impact the readability of the human-readable elements 504 of the display device 500. The fiducial blending engine 118 may then blend the fiduciary marker 506 with the human-readable elements 504 in each frame. For example, blending may include replacing a section of the human-readable elements 504 with a section of a fiduciary marker 506 where the human-readable elements and the machine-readable elements overlap. According to one embodiment, the fiducial blending engine 118 blends a continuous number of frames. In other embodiments, the fiducial blending engine 118 may blend every other frame or some staggered number of frames.

In one embodiment, the display device 500 is a device supporting two or more shades of gray. In this embodiment, the human-readable elements 504 are displayed primarily with one color, or shade of gray, with the background of the display device 500 rendered in a contrasting color or a shade of gray. The machine-readable element may be composed of a series of blocks (based on pixels), with each block being a shade of gray or white to match and contrast the background color of the display device 500. In one embodiment, a portion (e.g., one or more pixels) of machine-readable element 506 has a color or shade that matches a light portion (e.g., a white area) of the overlapping human-readable elements. In this embodiment, the portion of overlapping pixels is slightly darkened by either adjusting a shade value or to selecting a darker color. The difference of the shade or color may be sufficient enough for a device, such as the mobile computing device 404 of FIG. 4, to detect the difference within a captured frame, but still barely perceptible to an unaided human eye (i.e., obscured). It should be understood that in at least one embodiment the machine-readable elements do not overlap human-readable elements and, therefore, do not require blending. However, it should be understood that machine-readable elements may still be rendered in a color or shade that maintains the readability of the human-read element by not distracting a human viewing the display device 500.

In one example, the fiduciary marker 506 is illustrated as a QR-type code in FIG. 5 and may be superimposed on the human-readable elements 504 within the same frame. In this example, the superimposed QR code 506 is comprised of block elements with each block element colored black or white. The block elements of the QR code 506 which overlap the human-readable elements are adjusted in color or shade to differentiate the QR code 506 from the overlapping human-readable elements 504. Various color and shading options may be utilized to perform such differentiation. For example, the black block elements of the QR code 506 which overlap white portions of the human-readable elements within a frame may be changed to a darker shade (e.g., shade level 2). It should be understood that any overlapping element of the QR code 506 may be shaded darker or lighter to differentiate the overlapping element from that of the overlapped human-readable element. It should be further understood that shading may be performed on a per-block element basis or a per-pixel basis for the overlapping portions of the fiduciary marker 506.

It should be understood that in various embodiments the blending and interleaving discussed above may be combined to achieve desired visual output using the display device 600. For instance, every fifth frame may include blending and replacement of portions of the frame with machine-readable elements while every seventh frame is replaced by a frame including one or more machine-readable elements. In yet another embodiment, a frame may be displayed with one or more blended machine-readable elements wherein the overlapping portions are contrasted similarly to the human-readable elements 504 as discussed in some embodiments above. Various advantages may be realized by blending multiple machine-readable elements in the same frame. For example, by blending two or more fiduciary markers in the same screen space, the screen space may be utilized more efficiently, without reducing the detectability of the fiduciary markers from within captured frames. In further embodiments, the blending may be based on quadrants of the display device 500 as further to described below with reference to FIG. 6.

FIG. 6, with combined reference to FIG. 5, illustrates the display device 500 according to one embodiment generally designated at 600. In the shown embodiment, the display device 600 includes a plurality of quadrants at 602, 604, 606 and 608 and fiduciary markers 610, 612, 614, 616, 618 and 620. As discussed above with reference to FIG. 5, the fiduciary markers included within a frame may vary in type, number, size, shape, and relative position. As described further below, these variations may be used by different embodiments to achieve desired visual outputs.

According to one embodiment, the fiduciary marker may be a QR code such as QR codes 610, 612, 616, 616 and 618. In certain other embodiments, fiduciary markers may be a one-dimensional bar code such as bar code 620. It should be understood that different types of fiduciary markers may be mixed together and that the use of one does not preclude the use of another. In addition, various other fiduciary markers exist, and this disclosure is not limited to the one or two-dimensional bar codes specifically referenced in this disclosure. For example, any machine-readable code or symbol may be interleaved and/or blended by the fiducial blending engine 100 (FIG. 1) and displayed via the display device 600.

In some embodiments, a series of associated fiduciary markers may be visualized by the display device 600. In this manner, the visualization of a series of associated fiduciary markers may be used to transfer data between devices. The association between fiduciary markers may be identifiable from one or more of the characteristics of the fiduciary markers. For example, the spatial properties of one or more of the fiduciary markers 610-620 may be used to identify an association. An association between two or more fiduciary markers may be determined, for example, but virtue of the fact that two or more fiduciary markers have the exact same position, or position with a particular quadrant. In other examples, a temporal relationship between two or more fiducial markers may indicate an association. In still other examples, the type of fiduciary marker may indicate an association between two or more fiduciary markers. In these examples, the occurrence of a first QR code followed by a second QR code, different from the first, may indicate an association between the first and second QR code regardless of the spatial and temporal relationship. In still further examples, the data encoded within the fiduciary marker may indicate an association between two or more fiduciary markers. Encoded values such as an incrementing ID, a unique ID, linked-list style pointers, and other techniques of identifying sequences of data may be utilized. It should be understood that any combination of spatial, temporal and encoded data approaches may be used to associate two or more fiduciary markers.

In some embodiments, fiduciary markers may be used to delineate the start of a transmission and the end a transmission. The transmission may be any number of associated fiduciary markers in a sequence communicated by the device display 600. In one embodiment, a user may operate the interface buttons 502 (FIG. 5) to begin a particular sequence of data. In other embodiments, the display device 600 may continually cycle through different types of sequences of fiduciary markers. For example, the display device 600 may communicate a first sequence of fiduciary markers corresponding to measurement values of a sensor, such as from the sensor 206 (FIG. 2) of the programmable device 200. After communicating the first sequence of fiduciary markers corresponding to the measurement values, the display device 600 may communicate a second sequence of fiduciary markers corresponding to the current status of the hardware device associated with the display device 600. It should be understood that a sequence of fiduciary markers may include one or more (e.g., in a group) displayed fiduciary markers in each respective frame.

In some other embodiments, sequences may be delineated from each other through one or more fiduciary markers or machine readable codes. In one embodiment, a fiduciary marker may represent a start-of-transmission (SOT) and another fiduciary marker may indicate an end-of-transmission (EOT). The SOT and EOT fiduciary marker may be repeated over a given number of frames to ensure the effective communication of the fiduciary markers to a device observing the display device. Likewise, any frames between the SOT and the EOT fiduciary marker may be repeated a fixed or user configurable number of times to ensure a device, such as the mobile computing device 404 discussed above with reference to FIG. 4, may capture each frame including a fiduciary element reliably. Referring to FIG. 4, in one embodiment the fiduciary marker 412 may be one such SOT/EOT fiduciary marker. It should be understood that a machine-readable symbol (e.g., a circle, a square, a rectangle) may also be used to indicate an SOT or EOT.

In some embodiments, fiduciary markers may be used to communicate the device characteristics of the display device 600 via an encoded configuration parameter. For example, a configuration parameter may indicate one or more display properties including a parameter representing the current frames per second and refresh rate of the display device 600. In these embodiments, the current frames per second may be used by a mobile computing device 404 (FIG. 4) to determine compatibility. In other embodiments, devices such as the mobile computing device 404 may instruct (e.g., using Bluetooth or other forms of near-field communication) the display device 600 to adjust the ratio of frames with machine-readable codes responsive to the determination that the current configuration parameters are incompatible with the mobile computing device 404.

In various embodiments it may be advantageous to display fiduciary markers in one or more quadrants such as the quadrants 602, 604, 606 and 608. In one embodiment, each quadrant 602-608 may be directed to a particular type of fiduciary marker to display.

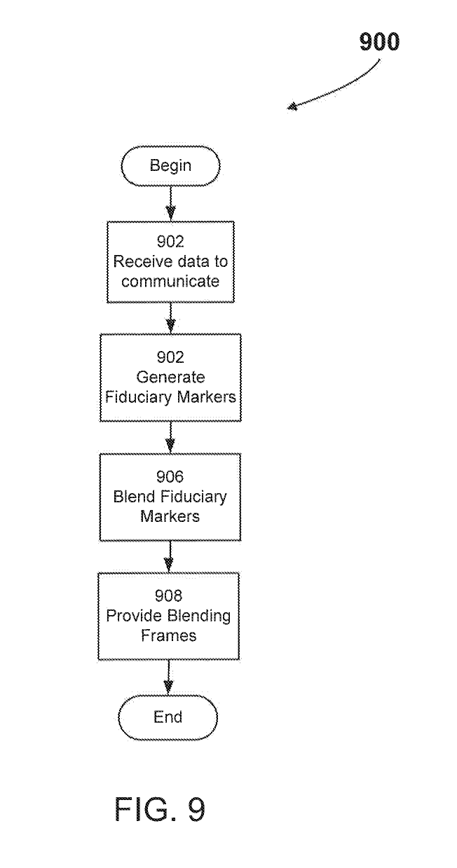

According to this embodiment, one quadrant may communicate one or more fiduciary markers which include, for example, sensor readings and other measurements such as from the sensor 206 of the programmable device 200 of FIG. 2. Another quadrant may communicate one or more fiduciary markers which include status information including, for example, an operational state or other status information of the hardware device associated with the display device 600, such as the computer system 112 of FIG. 1. It should be understood that a varying number of quadrants may be used to communicate one or more fiduciary markers. It should be further understood that fiduciary markers may transcend the boundary of more than one quadrant and are not limited to a single quadrant. For example, fiduciary marker 612 is displayed across multiple quadrants. In another example, a partial fiduciary marker, such as fiduciary marker 614 may appear in a first quadrant with a remaining portion appearing in a subsequently displayed frame. In this example, the display device 600 may be constrained as to the maximum number of pixels capable of being displayed. In certain embodiments, the fiducial detection process 900 of FIG. 9 may reconstruct the fiduciary marker 614 based on two or more frames with each frame having a portion of the entire fiduciary marker 614.

Further, in some embodiments, a device display 600 is partitioned into quadrants (i.e., areas or regions) and may update/refresh one quadrant more frequently than other quadrants to conserve hardware resources (e.g., in a constrained computing device). The enhanced refresh speed (or render speed) of a particular quadrant allows devices with constrained resources to render the machine-readable elements imperceptible without having to continually refresh the quadrants with only human-readable elements. In one embodiment each quadrant has a distinct refresh rate. In other embodiments two or more quadrants have an identical refresh rate.

In some embodiments, an enhanced refresh rate may be achieved by a fiducial engine 118 (FIG. 1) generating a partial frame with one or more machine-readable elements for rendering by a display interface 116 (FIG. 1). In some of these embodiments, the fiducial engine partially populates a frame (e.g., fills only a portion of the frame buffer) with data and to instructs the display interface 116 to render the partial frame as a complete frame. To this end, the instruction by the fiducial engine 118 to render the partial frame functions as an enhanced refresh of an area of the display interface 116 based on the frequency of the instruction. For example, the instruction executed 120 times per second would be equivalent to a 120 Hz refresh rate of the area. Thus in at least some embodiments, at least one horizontal or vertical line of pixels may be refreshed at an enhanced rate using the display interface 116 and a partial frame. It should be understood that the partial frame may include human-readable elements in addition the machine-readable elements. It should be further understood that a combination of enhanced refresh approaches may be utilized to achieve a desired result.

### Programmable Device

As discussed above with regard to FIG. 1, various aspects and functions described herein may be implemented as specialized hardware or software components executing in one or more programmable devices. These programmable devices are configured to independently (i.e., without instructions from a centralized control system) perform one or more specialized automated functions on a periodic basis. Programmable devices have a wide range of potential applications. The characteristics of particular types of programmable devices vary depending on the function that the programmable device is configured to perform. For instance, programmable devices configured for external use may include a rigid and insulated housing, while programmable devices configured to monitor environmental conditions may include one or more sensors configured to measure these environmental conditions. Some specific examples of programmable devices include uninterruptible power supplies, power and resource monitoring devices, protection relays, programmable logic controllers, and utility meters, such as a utility meter 200 as illustrated in FIG. 2.

As shown in FIG. 2, the utility meter 200 comprises a housing 202 that includes, a sensor 206, a processor 208, a memory 210, a data storage device 212, an interconnection element 214, and an interface 216. To implement at least some of the aspects, functions, and processes disclosed herein, the processor 208 performs a series of instructions that result in manipulated data. The processor 208 may be any type of processor, multiprocessor, or controller.

The memory 210 stores programs and data during operation of the utility meter 200. Thus, the memory 210 include any device for storing data, such as a disk drive or other non-volatile storage device, but typically includes a relatively high performance, volatile, random access memory such as a dynamic random access memory (DRAM) or static memory (SRAM). Various embodiments may organize the memory 210 into particularized and, in some cases, unique structures to perform the functions disclosed herein. These data structures may be sized and organized to store values for particular data and types of data.

As shown in FIG. 2, several of the components of the utility meter 200 are coupled to the interconnection element 214. The interconnection element 214 may include any communication coupling between components of the utility meter, such as one or more physical busses subscribing to one or more specialized or standard computing bus technologies such as IDE, SCSI, and PCI. The interconnection element 214 enables communications, such as data and instructions, to be exchanged between components of the utility meter 200.

The utility meter 200 also includes one or more interface devices 216 such as input devices, output devices and combination input/output devices. Interface devices may receive input or provide output. More particularly, output devices may render information for external presentation. Input devices may accept information from external sources. Examples of interface devices include buttons, keyboards, touch screens, network interface cards, and the like. Interface devices allow the utility meter 200 to exchange information with and to communicate with external entities, such as users and other systems.

The data storage device 212 includes a computer readable and writeable nonvolatile, or non-transitory, data storage medium in which instructions are stored that define a program or other object that is executed by the processor 208. The data storage 212 also may include information that is recorded, on or in, the medium, and that is processed by the processor 208 during execution of the program. More specifically, the information may be stored in one or more data structures specifically configured to conserve storage space or increase data exchange performance. The instructions may be persistently stored as encoded signals, and the instructions may cause the processor 208 to perform any of the functions described herein. The medium may, for example, be optical disk, magnetic disk or flash memory, among others.

As shown in FIG. 2, the sensor 206 is coupled to the processor 208. The sensor 206 includes an analog sensor and analog to digital converter to provide the processor 208 with a digital signal that represents a quantity of flow (e.g. usage) of a utility as detected by the analog sensor. The particular configuration of the sensor 206 varies depending on the utility being measured by the utility meter 200. For example, in an embodiment including a meter that measures electricity, the sensor 206 includes inputs for single phase or three phase power and records periodic measurements of one or more identified characteristics (e.g., power, voltage, current, etc.) of the electric circuit via the inputs. Upon receipt of these periodic measurements, the processor 208 stores information descriptive of the measurements and the times that the measurements were taken in the data storage element 212. Further, in some embodiments, the processor 208 subsequently transmits the stored information descriptive of the measurements to an external entity via a network interface included in the interface devices 216.

Some embodiments of the utility meter 200 include operational parameters that may be configured via protected functionality provided by the utility meter 200. These operational parameters may be used to configure CT/PT ratio, system type, demand calculations, I/O setup, onboard data logging, onboard waveform capture, and onboard alarming.

Although the utility meter 200 is shown by way of example as one type of utility meter upon which various aspects and functions may be practiced, aspects and functions are not limited to being implemented on the utility meter 200 as shown in FIG. 2. Various aspects and functions may be practiced on one or more utility meters having a different architectures or components than that shown in FIG. 2. For instance, the utility meter 200 may include specially programmed, special-purpose hardware, such as an application-specific integrated circuit (ASIC) tailored to perform one or more particular operations disclosed herein.

In some examples, the components of the utility meter 200 disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, to database servers, and web servers. Other examples of computer systems may include mobile computing devices, such as cellular phones and personal digital assistants, and network equipment, such as load balancers, routers, and switches. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302 and 304 and utility meter 200. As shown, the computer systems 302 and 304 and utility meter 200 are interconnected by, and may exchange data through, a communication network 308. The network 308 may include any communication network through which computer systems may exchange data. To exchange data using the network 308, the computer systems 302 and 304 and utility meter 200 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 302 and 304 and utility meter 200 may transmit data via the network 308 using a variety of security measures including, for example, TLS, SSL, or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions, and processes disclosed herein, the processor 310 performs a series of instructions that result in manipulated data. The processor 310 may be any type of processor, multiprocessor or controller. Some exemplary processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 310 is connected to other system components, including one or more memory devices 312, by the interconnection element 314.

The memory 312 stores programs and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein.

These data structures may be sized and organized to store values for particular data and types of data.

Components of the computer system 302 are coupled by an interconnection element such as the interconnection element 314. The interconnection element 314 may include any communication coupling between system components such as one or more physical busses in conformance with specialized or standard computing bus technologies such as IDE, SCSI, PCI and InfiniBand. The interconnection element 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Fiducial Blending Processes

As described above with reference to FIG. 1, several embodiments perform processes that communicate human-readable elements while simultaneously displaying machine-readable elements imperceptible, or nearly imperceptible (obscured), to an unaided human eye. In some embodiments, these fiducial blending processes are executed by a fiducial blending system, such as the fiducial blending system 100 described above with reference to FIG. 1. One example of such a fiducial blending system is illustrated in FIG. 7. According to this example, the fiducial blending process 700 includes acts of processing a fiducial blending request, generating frames and communicating frames. The fiducial blending process 700 may be executed in accordance with various device/computer embodiments as disclosed above. For example, the fiducial blending process 700 may be executed by the programmable device 106 as discussed above with reference to FIG. 1 or may be executed by the computer system 112 described above with reference to FIG. 1. Although one or more acts disclosed below are discussed in reference to either the programmable device 106 or the computer system 112, it should be understood that both the programmable device 106 and the computer system 112 are capable of executing any or all of the acts of the fiducial blending process 700.

At act 702, a programmable device of the fiducial blending system, such as the programmable device 106 described above with reference to FIG. 1, receives and processes a fiducial blending request from a process executed by a computer system, such as the computer system 112 described above with reference to FIG. 3. According to one embodiment, one or more processes may periodically issue requests for communicating data to an external entity via the fiducial blending engine. For example, a process may be monitoring one or more associated sensors, such as a process executed on the programmable device 200 (FIG. 2) monitoring the sensor 206 (FIG. 2), and may request measurement information to be communicated as human-readable elements, machine-readable codes, or any combination thereof. In other embodiments, a process monitoring one or more interface buttons, such as the interface buttons 502 discussed above with reference to FIG. 5, may cause one or more processes to request the communication of meta-data or configuration parameters via encoded fiduciary markers. In these embodiments, the user 102 (FIG. 1) may access one or more menus of a device, such as the programmable device 106 of FIG. 2, through the interface to buttons 502 and initiate communication of information as desired. For example, the user 102 may initiate the communication of diagnostic related data by selecting an appropriate operation on a particular menu of the programmable device 106 (FIG. 1) directed to diagnostic functions.

In act 704, the fiducial blending system 100 generates one or more frames with one or more fiduciary markers. In these examples, the fiducial engine 118 interacts with the display interface 116 to determine hardware capabilities of the display interface 116 and generates one or more frames with the data to be communicated, such as the data requested at act 702.

In act 706, a programmable device communicates the one or more frames generated in act 704 by the fiducial blending process 700. In one example, the display interface 116 (FIG. 1) may issue a call-back style request for the one or more frames to communicate. According to this example, the fiducial engine 118 (FIG. 1) may provide the one or more frames generated in act 704 to the display interface 116 responsive to the callback. In other examples, the fiducial engine 118 (FIG. 1) directs the display interface 116 (FIG. 1) to display the one or more frames generated in act 706. After the completion of the act 706, the fiducial blending process 700 determines if there is additional data remaining from the act 702 to be communicated. In one example, a process, such as a process executed by the computer system 112 of FIG. 1, may provide a continuous stream of data to be communicated. In this example, the fiducial blending process 700 returns to the act 702 and repeats the acts 704-706 until all of the requested data has been communicated.

In some embodiments, more than one process may have initiated a fiducial blending request 702. In these embodiments, the fiducial blending process 700 communicates a process-specific encoded frame (or sequence of frames) in a round-robin fashion. In other embodiments, the fiducial blending process 700 may communicate process-specific encoded frames (or sequence of frames) in a first-in-first-out (FIFO) queue. According to these embodiments, multiple display interfaces (and associated display devices such as the display device 500 of FIG. 5) may be utilized. For example, processes directed to monitoring a sensor, such as the sensor 206 of the programmable device 200 discussed above with reference to FIG. 2, may request measurement readings to be communicated via machine-readable elements output by a first display device. A second display may be then utilized by other processes requesting to communicate other information, such as diagnostic information. It should be understood that any number of display interfaces, and associated display devices, may be utilized to communicate machine-readable frames in accordance with this disclosure.

Once it has been determined that all of the data of the request for fiducial blending at to act 702 has been communicated, the fiducial blending system terminates the fiducial blending process 700.

Processes in accord with the fiducial blending process 700 enable a process (or a user based on input) to communicate one or more frames including machine-readable elements which are imperceptible to the unaided human eye. According to these processes, data may be communicated to an external entity without putting the programmable device or computer system into a special mode, or with the least amount of user-interaction necessary to communicate the data.

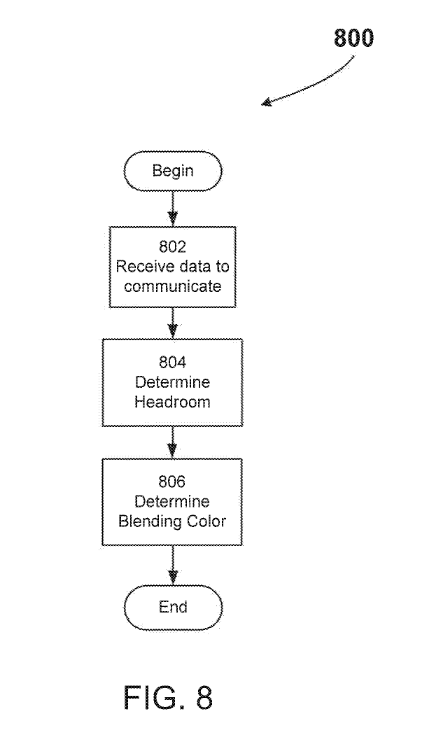

As described above with reference to the act 702, some embodiments perform processes through which a fiducial blending system 100 (FIG. 1) receives and processes a fiducial blending request from a process executed by the programmable device 106. One example of such a fiducial blending request process is illustrated in FIG. 8. According to this example, the fiducial blending request process 800 includes acts of receiving data to be communicated, determining a headroom count and determining one or more blending colors. The headroom value, as discussed above with reference to FIG. 5, is a value representing the number of frames that may be altered or exchanged with no visible effect on the display as viewed by a user within view of the programmable device. In some embodiments, the headroom value is a constant based on parameters returned by the display interface 116 (FIG. 1). In other embodiments, this value may be computed based on the parameters returned by the display interface 116 of FIG. 1 (e.g., based on frame rate), or by other parameters available to the fiducial blending engine 118 of FIG. 1, such as a ratio parameter, discussed above with reference to FIG. 5, defining the number frames including human-readable elements versus machine-readable elements. According to some embodiments, the headroom value may be used to calculate an appropriate ratio of machine-readable frames to human-readable frames. It should be recognized that various embodiments disclosed herein do not require utilization of the headroom value if frames are not being interleaved. As discussed above with reference to FIG. 6, in at least one embodiment no frames are interleaved and the machine-readable elements are blended into frames with human-readable elements, with the overlapping portions of the machine-readable elements having a color or shade which maintains readability of the human-readable elements.

In act 806, one or more colors for blending may be determined in accordance with this embodiment. In one example, the data received to be communicated includes frames including the human-readable elements. In this example, a blending color is based on the position of the to machine-readable element and the position of the human-readable elements to be overlapped. In another example, the one or more blending colors may be based on a user-configurable parameter. In other examples, the one or more blending colors may be based on hardware restraints such as a two-color display device. In certain other embodiments, the blending color may also be used by the fiducial blending process 700 when interleaving frames to further differentiate two or more fiduciary markers displayed in a single frame.

Processes in accord with the blending request process 800 enable a programmable device to determine one or more parameters used by the fiducial blending process 700 that enable a programmable device to optimize the communication of machine-readable elements while maintaining readability of the human-readable elements.

As described above with reference to the act 704, some embodiments perform processes through which a fiducial blending system that generates one or more frames. One example of such a frame generating process is illustrated in FIG. 9. According to this example, the frame generation process 900 includes acts of receiving data to communicate, generating fiduciary markers, blending the fiduciary makers into one or more frames and providing the blended frames.

In act 902, a programmable device receives a frame generation request and data to communicate from a process via the fiducial engine 118. In one embodiment, the frame generation request is executed by the fiducial blending process 700 subsequent to the execution of the fiducial blending request 800.

In act 904, one or more fiduciary markers are generated based on the data received in act 902. In one embodiment, the fiducial blending engine encodes the data in one or more fiduciary markers such as two-dimensional QR codes and one-dimensional bar-codes. For example, the fiducial blending engine may encode a portion of the data (e.g., a device identifier) as a one-dimensional barcode and encode another portion of the data (e.g., a measurement value) as a two-dimensional barcode (e.g., a QR code). In various embodiments, the color of one or more fiduciary markers is different from other fiduciary markers based on, for example, the blending color determined in act 806 of FIG. 8. As discussed above with reference to FIGS. 6 and 8, various embodiments may utilize varying color or shade values for the purpose of differentiating fiduciary markers from other fiduciary markers, or from overlapping human-readable elements when displayed.

In act 906, the generated fiduciary markers may be blended in pre-allocated frames, or frames may be allocated from memory accessible by the fiduciary engine 118. In certain to embodiments, part of the data received in act 902 includes one or more frames with human-readable elements. In these embodiments, the fiducial blending engine may blend the one or more generated fiduciary markers with the human-readable elements using the color determined in act 806 of the fiducial blending request process 800 discussed above with reference to FIG. 8. In certain other embodiments, the fiducial blending engine 118 may interleave one or more frames including the one or more fiduciary markers. In still other embodiments, the fiducial blending engine 118 may interleave frames including the fiduciary markers with one or more frames including blended human-readable and machine-readable elements.

Processes in accord with the frame generation process 900 enable a programmable device to generate one or more frames with machine-readable elements blended in a manner that is imperceptible, or virtually imperceptible (obscured), to the unaided human eye.

One example of a fiducial detecting process of the communication device 108 is illustrated in FIG. 10. According to this example, the fiducial detecting process 950 includes acts of capturing frames, detecting one or more fiduciary markers, decoding the encoded information from the one or more detected fiduciary markers and communicating the decoded information.

In act 952, a communication device of the fiducial blending system 100 (FIG. 1), such as the communication device 108 described above with reference to FIG. 1, is configured with a built-in image capture device which captures a plurality of frames from a field of view of a programmable device 106 (FIG. 1). In one example, the field of view includes the display device associated with a display interface 112 (FIG. 1) of the programmable device 106. In other examples, the field of view includes two or more display devices associated with one or more display interfaces 112 of the programmable device 106.

In act 954, the communication device may detect one or more fiduciary markers from within the captured frames. In one embodiment, responsive to the detection of at least one fiduciary marker, the communication device or the programmable device may indicate to a user that at least one fiduciary marker has been detected or communicated. In other embodiments, responsive to the detection of at least one fiduciary marker, the communication device enters act 956. As will be discussed below in reference to act 958, in certain other embodiments, the captured frames may be stored in memory and later transferred to another computer system, such as the data center manager 120 as discussed above with reference to FIG. 1, without being further processed by the communication device 108.

In act 956, the communication device of the fiducial blending system 100 (FIG. 1), such as the communication device 108 described above with reference to FIG. 1 or the data center manager 120 described above with reference to FIG. 1, decodes information from at least one fiduciary marker subsequent to the detection of the least one fiduciary marker in act 954. In one embodiment, the communication device 108 only captures a plurality of frames for later processing by the data center manager 120. In this embodiment, the plurality of frames may be communicated via network 110 from the communication device 108 to the data center manager 120. In at least one embodiment, only a portion of a fiduciary marker may be detected in at least one frame. In this embodiment, a device of the fiducial blending system 100 (FIG. 1), such as the communication device 108 described above with reference to FIG. 1 or the data center manager 120 described above with reference to FIG. 1, reconstructs a fiduciary marker based on two or more frames including a portion of a complete fiduciary marker.

In act 958, the communication device 108 (FIG. 1) or the data center manager 120 (FIG. 1) communicates the decoded information to the user 102 (FIG. 1). In one embodiment, the communication device 108 (FIG. 1) displays the decoded information to the user. In certain other embodiments, the communication device interprets the decoded information and displays one or more values based on the decoded information. For example, if the decoded information includes a measurement value in Celsius, the communication device 108 (FIG. 1) may convert the measurement value to Fahrenheit for display. In another example, the decoded information may include a stream of data including multiple measurement values of one or more sensors, such as from the sensor 206 of the meter 200 of FIG. 2, or diagnostic values. Other examples include presenting a list of operations which may be performed on the programmable device 106, or through the data center manager 120, based on the decoded information. In these examples, decoded information may be a parameter representing an operational state. The communication device 108 may than provide a menu of actionable elements each of which enables a user to change the operational state to a different value by executing a command using Near-Field Communication (e.g., using Bluetooth or WiFi®).

Processes 700-950 each depict one particular sequence of acts in a particular embodiment. The acts included in these processes may be performed by, or using, one or more computer systems or programmable devices specially configured as discussed herein. Some acts are optional and, as such, may be omitted in accord with one or more embodiments. Additionally, the order of the acts can be altered, or other acts can be added, without departing to from the scope of the embodiments described herein. Furthermore, as described above, in at least one embodiment, the acts are performed on particular, specially configured machines, namely a fiducial blending system configured according to the examples and embodiments disclosed herein.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system for communicating at least one human-readable element and at least one fiduciary marker, the system comprising:
a programmable device comprising:
a memory;
a display; and
at least one processor coupled to the memory and configured to:
generate a plurality of frames that render the at least one human-readable element perceptible to human view during display of the plurality of to frames via the display, that render the at least one fiduciary marker detectable to an image capture device during display of the plurality of frames via the display, and that obscure the at least one fiduciary marker from human view during display of the plurality of frames via the display; and
display the plurality of frames via the display.

2. The system according to claim 1, wherein the programmable device is at least one of a programmable logical controller, a utility meter, a protection relay, and an uninterruptible power supply.

3. The system according to claim 1, wherein the at least one processor is configured to generate the plurality of frames by generating a plurality of frames that render the at least one fiduciary marker imperceptible to human view.

4. The system according to claim 1, wherein the at least one fiduciary marker includes at least one of a quick response code and a one-dimensional bar code.

5. The system according to claim 1, wherein the display is configured to display a plurality of distinct colors including a first color and a second color and the at least one processor is further configured to:
render at least one frame of the plurality of frames to include the at least one human-readable element in the first color and the at least one fiduciary marker in the second color; and
render an overlaid image within the at least one frame, the overlaid image including at least a portion of the at least one human-readable element and at least one portion of the at least one fiduciary marker.

6. The system according to claim 1, wherein at least one frame of the plurality of frames includes at least one portion of the at least one fiduciary marker, and at least one other frame of the plurality of frames includes at least one remaining portion of the at least one fiduciary marker.

7. The system according to claim 1, wherein the plurality of frames includes at least one frame including only the at least one fiduciary marker.

8. The system according to any of claims 1-7, wherein each frame of the plurality of frames is partitioned into a plurality of areas, each area of the plurality of areas having a distinct rendering speed, and the at least one processor is configured to display at least a portion of the at least one fiduciary marker within an area of the plurality of areas having a rendering speed that is faster than a rendering speed of another area of the plurality of areas.

9. The system according to claim 1, wherein the at least one fiduciary marker includes at least one encoded parameter associated with the programmable device.

10. The system according to claim 9, wherein the at least one encoded parameter includes a sensor value.

11. The system according to claim 9, wherein the at least one encoded parameter includes at least one of an operational state, a global positioning system (GPS) location, a device ID, a model number, a serial number, an internet protocol (IP) address and a serial number.

12. The system according to claim 9, further comprising a first subset of the plurality of frames including a first fiduciary marker and a second subset of the plurality of frames including a second fiduciary marker.

13. The system according to claim 12, wherein at least one of the first fiduciary marker and the second fiduciary marker includes a synchronization image comprising at least one of a start-of-transmission parameter and an end-of-transmission parameter, the start-of-transmission parameter indicating a starting frame of at least one of the first subset and the second subset, the end-of-transmission parameter indicating an ending frame of at least one of the first subset and the second subset.

14. The system according to claim 9, further comprising a communications device including:
a memory;
an image capture device; and
at least one processor coupled to the memory and the image capture device, the at least one processor being configured to:
capture at least one frame of the plurality of frames using the image capture device;
identify the at least one least one fiduciary marker within the at least one frame; and
decode the at least one encoded parameter from the at least one fiduciary marker.

15. A method for communicating at least one human-readable element and at least one fiduciary marker using a computer system including a memory, a display, and at least one processor coupled to the memory and the display, the method comprising:
generating a plurality of frames that render the at least one human-readable element perceptible to human view during display of the plurality of frames via the display, that render the at least one fiduciary marker detectable to an image capture device during display of the plurality of frames via the display, and that obscure the at least one fiduciary marker from human view during display of the plurality of frames via the display; and
displaying the plurality of frames via the display.

16. The method according to claim 15, further comprising:
rendering at least one frame of the plurality of frames to include the at least one human-readable element in a first color and the at least one fiduciary marker in a second color; and
rendering an overlaid image within the at least one frame, the overlaid image including at least a portion of the at least one human-readable element and at least one portion of the at least one fiduciary marker.

17. The method according to claim 15, wherein rendering the at least one frame of the plurality of frames includes at least one portion of the at least one fiduciary marker, and at least one other frame of the plurality of frames includes at least one remaining portion of the at least one fiduciary marker. to 18. A programmable device for detecting at least one obscured fiduciary marker, the programmable device comprising:
a memory;
an image capture device; and
at least one processor coupled to the memory and the image capture device, the at least one processor being configured to:
capture a plurality of frames from a screen using the image capture device, the plurality of frames including the at least one obscured fiduciary marker and at least one human-readable element;
identify the at least one obscured fiduciary marker within at least one frame of the plurality of frames; and
store the at least one obscured fiduciary marker in the memory.

19. The programmable device of claim 18, the programmable device further including a display and wherein the at least one processor is further configured to:
decode information encoded within the at least one obscured fiduciary marker; and
display the decoded information via the display.

20. The programmable device of claim 18, wherein the at least one frame includes a first frame and a second frame, and the at least one processor is further configured to:
detect the first frame including a first portion of the at least one obscured fiduciary marker;
detect the second frame including a second portion of the at least one obscured fiduciary marker;
combine the first portion and the second portion to render a complete fiduciary marker; and
store the complete fiduciary marker in the memory.
